(19) United States
(12) Patent Application Publication
(10) Pub. No.: US 2011/0244832 A1
(43) Pub. Date: Oct. 6, 2011

(54) SYSTEM AND METHOD OF STORING TELEPHONE CONVERSATIONS

(76) Inventor: Christopher Anthony SILVA, Little Egg Harbor, NJ (US)

(21) Appl. No.: 13/164,079

(22) Filed: Jun. 20, 2011

Related U.S. Application Data
(63) Continuation-in-part of application No. 12/552,217, filed on Sep. 1, 2009.

(51) Int. Cl. H04M 1/725

(52) U.S. Cl. 455/412.1

(57) ABSTRACT

A method and system of storing telephone conversation data to a third party database storage unit is disclosed. The method includes detecting a telephone call initiated in a mobile telephone, recording telephone conversation data, detecting a termination of the telephone call, and transferring the recorded telephone conversation data to a third party database storage unit. The telephone call can be tagged with an identification. In one embodiment, a recording can be made at the mobile telephone and forwarded to the third-party database storage unit. The system includes an application program interface installed on a mobile telephone, an internet gateway, and a third party database storage unit configured to store data recorded by the application program interface.

### CROSS REFERENCE TO RELATED APPLICATION

This application is a continuation-in-part of U.S. patent application Ser. No. 12/552,217 filed Sep. 1, 2009, the entirety of which is hereby incorporated by reference into this application.

### BACKGROUND OF THE INVENTION

1. Field of the Invention

The present invention generally relates to data storage, and more particularly, to archiving mobile telephone call data.

2. Description of Related Art

Increasing popularity in conducting business via mobile telephones has led to, in some instances, in the loss of or poor record keeping of discussed material. Two or more people conducting, for example, a business cell from various locations may discuss specific transactional details that may be lost or inaccurately remembered once the call is terminated.

Additionally, some mobile telephones may be equipped with multiple applications requiring extensive memory storage. Thus, the distribution of data files and management of data space within a mobile telephone may be at a premium.

As can be seen, there is a need for a method and system of recording telephone conversations for accurate record keeping.

### SUMMARY OF THE INVENTION

In one aspect of the present invention, a method of storing telephone conversation data comprises detecting a telephone call initiated in a mobile telephone producing the telephone conversation data; recording the telephone conversation data; detecting a termination of the telephone call; and transferring the recorded telephone conversation data to a third party database.

In another aspect of the present invention, a system for storing telephone conversation data comprises an application program interface installed on a mobile telephone configured to store data associated with a telephone call initiated by or received by the mobile telephone; an Internet gateway configured to receive wireless signal transmissions of the data from the mobile telephone; and a database storage unit connected to the internet gateway wherein the database storage unit is located externally of the mobile telephone and wherein the database storage unit is configured to store the data received from the internet gateway.

In one embodiment, a user interface allows a user to enter a predetermined identification which can be tagged to the telephone conversation data prior to transfer to the data storage unit for subsequent expeditious identification of the call. This information can be optionally selected prior to any recording, chosen at the end of the recording, or entered at the beginning or end of the recording if the desired data element is not present in the predetermined list. The user can select calls to be recorded based on one or more conditions, such as, for example, dialed number information, caller ID information, calls within a certain radius of a GPS location, incoming status and outgoing status.

In one embodiment, the user interface allows the mobile phone to be used as a recorder by recording a conversation with a speaker phone microphone. The user can enter a predetermined or user entered identification which can be tagged to the recorded conversation prior to transfer to the data storage unit for subsequent expeditious identification of the recorded call.

In one embodiment, a remote administrator can initiate recording at the mobile phone. A device of the mobile phone, such as, for example, a microphone, camera or alternate device connected with a wired or wireless connection can be activated to initiate recording. The remote administrator can initiate the recording, for example, by using a short message service (SMS) message, establishing a call with the mobile phone and supplying of a code, establishing an Internet connection, sensing a Global Positioning Service (GPS) location, or sensing an environment of the user. For example, the environment of the user can be related to sensing the speed of movement of the mobile phone, sensing a shock to the mobile phone, sensing a temperature of the mobile phone, sensing a heart rate of a user of the mobile phone and sensing availability of a network of the mobile phone.

The data storage unit can also capture short message service (SMS) messages and multimedia messaging (MMS) messages. The data storage unit can then store the audio, any recorded audio, and any data or messages presented independently of the audio and store the data for future use.

These and other features, aspects and advantages of the present invention will become better understood with reference to the following drawings, description and claims.

### BRIEF DESCRIPTION OF THE DRAWINGS

FIG. 1 is a block diagram depicting a system according to an exemplary embodiment of the present invention; and

FIG. 2 is a flowchart illustrating a series of steps according to an exemplary embodiment of the present invention.

FIG. 3 is a flowchart illustrating a series of steps according to an exemplary embodiment of the present invention.

### DETAILED DESCRIPTION OF THE INVENTION

The following detailed description is of the best currently contemplated modes of carrying out exemplary embodiments of the invention. The description is not to be taken in a limiting sense, but is made merely for the purpose of illustrating the general principles of the invention, since the scope of the invention is best defined by the appended claims.

Various inventive features are described below that can each be used independently of one another or in combination with other features.

Broadly, embodiments of the present invention generally provide a method and system for storing data associated with telephone conversations to a third party site for archival and future playback.

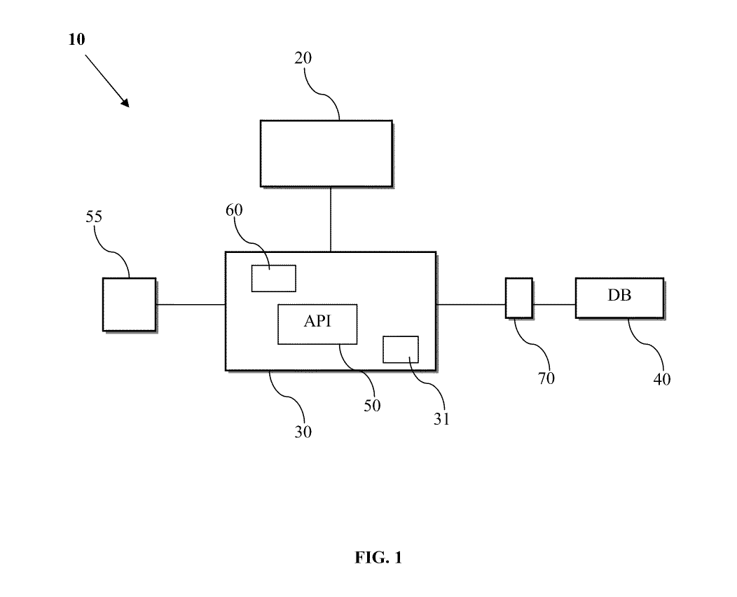

Referring to FIG. 1, system 10 according to an exemplary embodiment of the present invention, may generally include mobile telephone 30, internet gateway 70 and third party database storage unit 40. Mobile telephone 30 may further include memory storage module 60 and application program interface 50, such as a telephony application program interface (TAPI). System 10 may also include second telephone unit 20 that may either send or receive a telephone call from mobile telephone 30. It will be understood that telephone unit 20 may be either a landline connected telephone or another mobile telephone.

Application program interface 50 may be resident on mobile telephone 30 and run in the background while having no visual or audible indication that it is running A user interface (not shown) may be password protected. Application program interface 50 can allow a user to enter a predetermined identification or identification entered manually prior or subsequent to the recording which can be tagged to the recorded conversation prior to transfer to the database storage unit for subsequent expeditious identification. Application program interface 50 may allow the application access to a full duplex telephone conversation of audio data. Application program interface 50 may compress the audio data using any standard or nonstandard audio compression standards such as GSM, G.729a, G.711, etc.

Other call data associated with a telephone call may include a call direction for example, inbound vs. outbound, a duration of a call, a date and time the call began, a caller identification, and a dialed number. The call data may be captured and stored in the audio file and/or accompany the audio file as a separate data file. Any data or messages presented independently of the audio can also be recorded at third-party database storage unit 40. For example, the messages can include short message service (SMS) messages and multimedia messaging (MMS) messages. It will be appreciated that other message types using for example text, pictures or video utilized by the mobile phone can be delivered to the recording server in accordance with the teachings of the present invention. The telephone audio data and call data associated with the telephone call and data or messages may be temporarily stored in memory storage module 60. Upon completion of the call and creation of the data file(s), the application will optionally insert a digital fingerprint, watermark, or encryption for integrity purposes and then copy the file(s) to the 3rd party database server via any wireless connection available to the cellular phone that will connect to the database server.

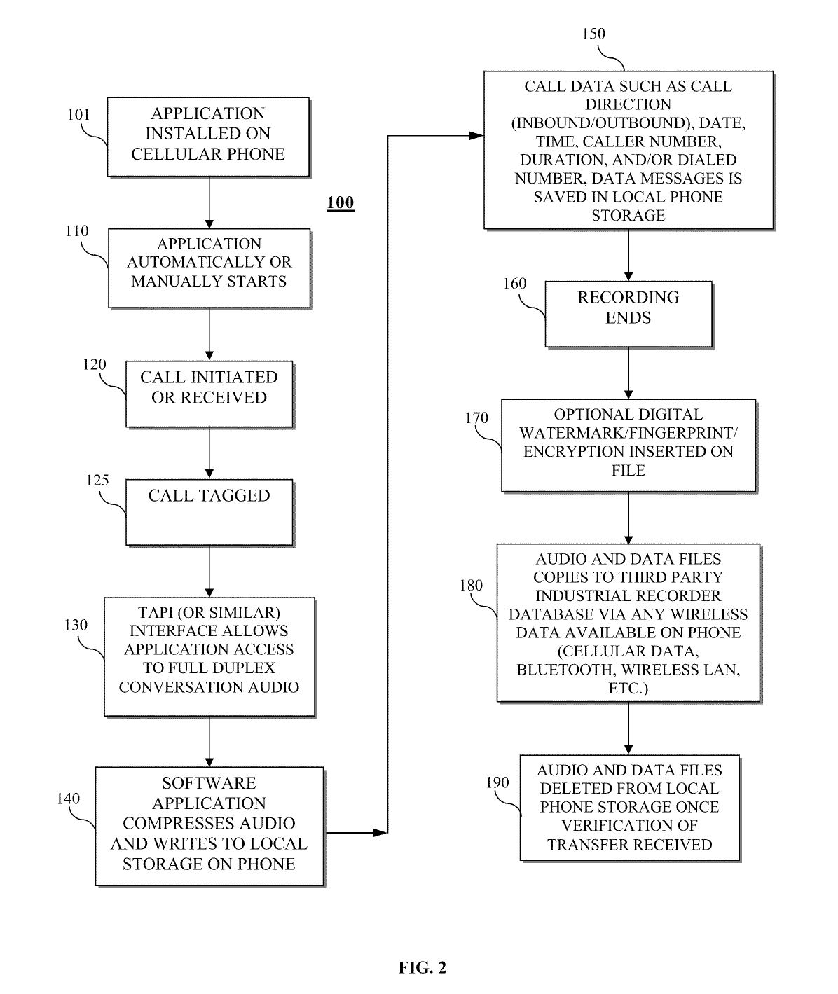

Referring now to FIGS. 1 and 2, method 100 according to an exemplary embodiment of the present invention is described. Method 100 may in step 101, identify that application program interface 50 is installed on mobile telephone 30. Application program interface 50 may be automatically started or manually started in step 110. In step 120, an initiated or received telephone call in mobile telephone 30 may be detected. In step 125, the telephone call can be tagged with an identification. Application program interface 50 may access and record the telephone conversation and associated data occurring during operation of mobile telephone 30 by a first user conducting a call with a second user on telephone unit 20. In step 140, audio data associated with the telephone conversation may be compressed into a waveform audio format and stored in memory storage module 60. Other telephone conversation data associated with the telephone call and data messages may be accessed and stored in memory storage module 60 in step 150. The other telephone conversation data associated with the telephone call may include call direction, date of the call, time of the call, a caller number of telephone unit 20, and duration of the call. In step 160, termination of the telephone call may be recognized. In step 170, the telephone conversation data may be watermarked, fingerprinted, or encrypted within memory storage module 60. In step 180, the telephone conversation data may be transmitted wirelessly to internet gateway 70 and transferred for storage into third party database storage unit 40. In step 190, the telephone conversation data may be deleted from memory storage module 60 once verification of the transfer of the telephone conversation data to third party database storage unit 40 is received by mobile telephone 30.

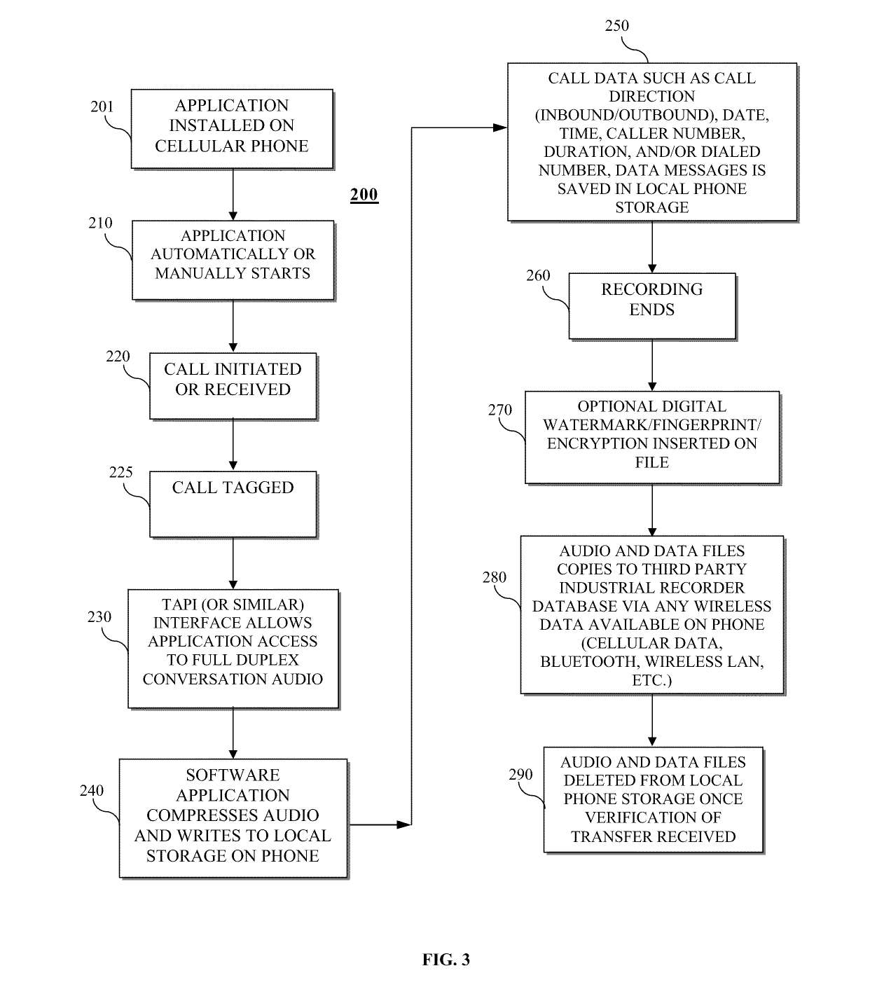

Referring now to FIGS. 1 and 3, method 200 according to an exemplary embodiment of the present invention is described. Method 200 can in step 201, identify that application program interface 50 is installed on mobile telephone 30. In one embodiment, a device of mobile telephone 31, such as, for example, a microphone, camera or alternate device connected with a wired or wireless connection can be activated to initiate recording. Application program interface 50 may be automatically started or manually started in step 210. Remote administrator 51 can initiate the recording for example, by using a short message service (SMS) message, establishing a call with the mobile phone and supplying of a code, establishing an Internet connection, sensing a Global Positioning Service (GPS) location, or sensing an environment of the user. For example, the environment of the user can be related to sensing the speed of movement of the mobile phone, sensing a shock to the mobile phone, sensing a temperature of the mobile phone, sensing a heart rate of a user of the mobile phone and sensing availability of a network of the mobile phone. In step 220, a recording can be initiated using mobile telephone 30. In step 225, the recording can be tagged with an identification. A user can enter a predetermined identification application program interface 50 which can be tagged to the recording prior to transfer to the centralized recording server for subsequent expeditious identification.

In step 240, audio data associated with the recording may be compressed into a waveform audio format and stored in memory storage module 60. Data associated with the recording may be accessed and stored in memory storage module 60 in step 250. Any data messages presented independently of recording can be stored in memory storage module 60. For example, the database messages can include short message service (SMS) messages and multimedia messaging (MMS) messages. It will be appreciated that other message types using for example text, pictures or video utilized by the mobile phone can be delivered to the recording server in accordance with the teachings of the present invention. In step 230, TAPI or similar interface allows application program interface 50 access to the recording. In step 260, termination of the recording may be recognized. In step 270, the recording data may be watermarked, fingerprinted, or encrypted within memory storage module 60. In step 280, the recording data may be transmitted wirelessly to internet gateway 70 and transferred for storage into third party database storage unit 40. In step 290, the recording may be deleted from memory storage module 60 once verification of the transfer of the recording to third party database storage unit 40 is received by mobile telephone 30.

It should be understood, of course, that the foregoing relates to exemplary embodiments of the invention and that modifications may be made without departing from the spirit and scope of the invention as set forth in the following claims.

What is claimed is:

1. A method of storing telephone conversation data, comprising:
detecting a telephone call initiated in a mobile telephone producing the telephone conversation data;
recording the telephone conversation data;
detecting a termination of the telephone call; and
transferring the recorded telephone conversation data to a third party database storage unit.

2. The method of claim 1, further comprising compressing the telephone conversation data into a waveform audio format.

3. The method of claim 1, wherein transferring the recorded telephone conversation data is performed wirelessly.

4. The method of claim 1 wherein after the step of recording the telephone conversation data further comprising the step of:
tagging the telephone conversation with an identification.

5. The method of claim 1 further comprising the step of:
capturing short message service (SMS) messages and/or multimedia messaging (MMS) messages, and forwarding the captured messages independent of the telephone conversation to the third party database.

6. A method for recording at a mobile telephone comprising the steps of:
recording using the mobile telephone;
transferring the recording server to a third party database storage unit.

7. The method of claim 6 wherein before the step of conferencing further comprising the step of:
tagging the recording with an identification.

8. The method of claim 6 wherein said step of conferencing a recording server is performed automatically.

9. The method of claim 6 wherein the step of conferencing is performed automatically based on one or more of dialed number information, caller ID information, calls within a certain radius of a GPS location, incoming status and outgoing status.

10. The method of claim 6 wherein the step of recording is initiated remotely.

11. The method of claim 10 wherein the recording is initiated by a short message service (SMS) message, establishing a call with the mobile phone and supplying of a code, establishing an Internet connection, sensing a Global Positioning Service (GPS) location, or sensing an environment of the user.

12. The method of claim 11 wherein the sensing of an environment of a user comprises one or more:
sensing the speed of movement of the mobile phone;
sensing a shock to the mobile phone;
sensing a temperature of the mobile phone;
sensing a heart rate of a user of the mobile phone; and
sensing availability of a network of the mobile phone.

13. The method of claim 6 wherein said step of conferencing a recording sever is performed on demand.

14. A system for storing telephone conversation data, comprising:
an application program interface installed on a mobile telephone configured to store data associated with a telephone call initiated by or received by the mobile telephone and tag the telephone call;
an internet gateway configured to receive wireless signal transmissions of the data from the mobile telephone; and
a third party database storage unit connected to the internet gateway wherein the database storage unit is located externally of the mobile telephone and wherein the third party database storage unit is configured to store the data received from the internet gateway.

15. The system of claim 14 wherein:
the application program interface is configured to capture short message service (SMS) messages and/or multimedia messaging (MMS) messages, and
forwarding the captured messages to the third-party database independent of the data associated with the telephone call.

16. A system for recording at a mobile telephone comprising:
an application interface installed on a mobile telephone configured to store data associated with a recording using the mobile telephone;
an internet gateway configured to receive wireless signal transmissions of the data from the mobile telephone; and
a third party database storage unit connected to the internet gateway wherein the database storage unit is located externally of the mobile telephone and wherein the third party database storage unit is configured to store the data received from the internet gateway.

17. The system of claim 16 wherein the application program is further configured to attach a digital fingerprint to the data.

18. The system of claim 16 wherein the recording at the application program interface is performed automatically based on one or more of dialed number information, caller ID information, calls within a certain radius of a GPS location, incoming status and outgoing status.

19. The system of claim 16 wherein the recording is initiated remotely.

20. The system of claim 19 wherein the recording at the application program interface is initiated by a short message service (SMS) message, establishing a call with the mobile phone and supplying of a code, establishing an Internet connection, sensing a Global Positioning Service (GPS) location, or sensing an environment of the user.

21. The system of claim 20 wherein the sensing of an environment of a user comprises one or more of:
sensing the speed of movement of the mobile phone;
sensing a shock to the mobile phone;
sensing a temperature of the mobile phone;
sensing a heart rate of a user of the mobile phone; and
sensing availability of a network of the mobile phone.
